(19) United States
(12) Patent Application Publication
(10) Pub. No.: US 2018/0268359 A1
(43) Pub. Date: Sep. 20, 2018

(54) METHOD AND SYSTEM FOR PROVIDING MULTI-DESTINATION DYNAMIC ROUTING IN LOGISTICS

(71) Applicant: Sahoo SOUBHAGYA, Mumbai (IN)

(72) Inventor: Sahoo SOUBHAGYA, Mumbai (IN)

(21) Appl. No.: 15/548,106

(22) PCT Filed: Feb. 5, 2016
(86) PCT No.: PCT/IN2016/000039

§ 371 Date: Aug. 2, 2017

(30) Foreign Application Priority Data
Feb. 7, 2015 (IN) 408/MUM/2015

(51) Int. Cl. G06Q 10/08; G08G 1/01; G06F 3/01

(52) U.S. Cl. CPC G06Q 10/0833; G06F 3/017; G08G 1/0133; G08G 1/0112

(57) ABSTRACT

Method and system for providing multi-destination dynamic routing and optimal route plan in logistics using a multi-destination dynamic routing application is disclosed. The system comprising of a remote centralized server on the backend and a mobile application working on a device that interacts with the remote centralized server, either frequently, if there is an internet connection, or automatically whenever there is any connectivity or using messaging protocol in case of no internet connectivity. The remote centralized server provides the User a means for feeding inputs, managing other users, changing user settings, downloading routes, tasks, priorities and making the feedback available for all other Users. Further the User of the delivery vehicles logs in and synchronizes his device with the server at the beginning of the work-day to download all the route, directions, destinations and user tasks. User can also add custom drops and re-route when the User desires.

### FIELD OF INVENTION

The present disclosure relate generally to the field of vehicle navigation and route guidance system. Embodiments relate more particularly to a method and system of providing multi-destination dynamic routing and optimal route planning in logistics.

### BACKGROUND OF INVENTION

In this modern economy, the transportation or delivery of products and people is increasingly significant to the success of an organization. Any physical product delivery including online shopping stores must transport products to their customers with every order in due time. Organizations allocate a high level of logistic resources in order to manage the transportation of people to business locations and goods and products to their consumers in time. For example, most internet retailers rely on third-party services, to deliver the products purchased on their web sites. Most on-demand service providers E.g., Radio-taxi or restaurants need to enroute their multiple resources optimally to the business locations.

However, there are many potential problems associated while transporting goods to the consumers. For example, a courier boy calls the customer up for delivery and goes through multiple addressing and scheduling calls in order to finally deliver the goods after many unplanned delays, inconveniencing both the retailer as well as the consumer generally referred to as ‘last mile logistics’ problems. Further, there are so many other factors such as: minor accidents, vehicle damaging, heavy traffic jams, routine check by law enforcement authorities etc., which reduce the delivery targets considerably. Existing multi-drop routing solutions solve for Travelling Salesman Problem (TSP) for a single resource with few known constraints such as avoidance of tolls/highways or walking, cycling or bus paths etc. In emerging economies such as India, resource territories or usage boundaries often overlap, requiring multi-destination multi-resource planning. Also, toll does not emerge as an important factor in daily route planning as the tolls more than justify the benefits of time and/or fuel savings.

Further, drivers tend to subject their devices to rough usage, and in enterprise deployment cases, the tracking of device usage patterns such as device damage or device drops becomes an arduous task. Further, the existing traditional methods do not provide a solution for multi-destination dynamic routing and optimization of multiple drops. The delivery vehicle driver has to either take the printout of his desired road directions or the data should be exported into the GPS (Global Positioning Satellites) navigation device including destination entry, and information entry upon arrival at destination. Existing methods also do not support automatic assignment and queuing of multiple urgent requests from different locations based on real time driver availability.

In most of the cases, due to very little familiarity with such type of file import operations and route management, the end User more specifically the driver fails in reaching the destination in time. Moreover, existing routing solutions do not provide any integration with sales manifest or ordering Enterprise Resource Planning (ERP) software in common usage by enterprises. Also, these solutions do not provide any means of updating for emergency alerts, recent road construction or diversions, as a result, GPS navigation Users often feel helpless on encountering such an obstacle.

In the existing routing solutions, the User has to manually touch the screen of the navigating device for managing the maps. These actions are quite difficult and inconvenient in a two-wheeler or any other moving vehicle as the screen is subject to shakes, bumps and jolts, while the User is trying to stabilize his finger and vehicle movements.

Also, when it comes to parking spots, the existing solutions provides very little real time information on the number of spots available, or number of vehicles parked or number of vehicles waiting to park or any unmarked parking spots. As a result, even if parking information is gathered systematically, the parking is usually occupied or invalid by the time the User receives the information.

In the light of the above discussion, there appears to be a need for a system and method which provides the Users, particularly for the delivery vehicle drivers, with an optimal route plan and multi-destination dynamic routing while moving from a source location to a destination location along with the features like advanced navigation and communication technology, availability of parking spot information, updates for emergency alerts, or recent road construction or diversions and so on.

### SUMMARY OF THE INVENTION

The summary represents the simplified condensed version of the claimed subject matter and it is not an extensive disclosure of the claimed subject matter. The summary neither identifies key or critical elements nor delineates the scope of the claimed subject matter. The summary presents the simplified form of the claimed subject matter and acts as a prelude to the detailed description that is given below.

An aspect of the invention provides for a method and system for multi-destination dynamic routing and optimal route plan in logistics using a multi-destination dynamic routing application. The method comprises of synchronizing at least one user device with a remote centralized server by establishing communication between at least one user device and the remote centralized server.

The method further comprises of providing the remote centralized server with at least one input corresponding to at least one User current location and destination location via user device and downloading at least one route map associated with at least one route between the current location and the destination location from the remote centralized server to at least one user device.

The method further provides access to at least one User for manipulating at least one downloaded route map and tracking and obtaining by the user device from the remote centralized server at least one User location on at least one route between the current location and the destination location at plurality of time instances.

The method further provides for optimal delivery in logistics comprising of combining closely located destinations for same deliveries using same vehicle by a metric called clustering, only if the located destinations are both large such that they attract each other towards a central point.

The method and system further comprising of a Remote centralized server on the backend and a User device that interacts with the Server, either frequently, if there is an internet connection, or automatically whenever there is any connectivity or using messaging protocol in case of no internet connectivity. The remote centralized server provides the User a means for feeding inputs, managing other users, changing user settings, downloading route map, downloading user tasks, obtaining updates in the nature of emergency alerts, recent road constructions, diversions and making the feedback available for all other Users and so on. The method and system further comprising of the remote centralized server communicating to the user device, in its navigation map view, at least one other User travelling on the same route such that similar such travelers are coordinated to stay and travel in multiple vehicles by providing a multi-digit route identity

The method and system further comprising of tracking the user device by the remote centralized server at predefined durations and intervals to log the precise user locations for real time access. The method and system further comprising of tracking the user device and user delivery completion status by the remote centralized server at predefined durations and intervals to track the precise user locations and precise new pickup and delivery requests in real time and assign optimal mapping of pickup requests to the best suited drivers, such that they are able to meet the previously agreed upon pickup and delivery timelines, subject to availability of riders.

### BRIEF DESCRIPTION OF FIGURES

The features, advantages and other aspects of the embodiments of the present invention will be obvious to any person skilled in the art to appreciate the invention when read with the following description taken in conjunction with the accompanying drawings.

In the accompanying figures, similar reference numerals may refer to identical or functionally similar elements. These reference numerals are used in the detailed description to illustrate various embodiments and to explain various aspects and advantages of the present disclosure.

FIG. 1 is a block diagram of the Multi-destination dynamic routing application System, according to the embodiments as disclosed herein;

FIG. 2 is a block diagram depicting the modules in a Remote centralized server associated with the Multi-destination dynamic routing application System, according to the embodiments as disclosed herein;

FIG. 3 is a block diagram depicting the modules in a User Device associated with the Multi-destination dynamic routing application System, according to the embodiments as disclosed herein;

FIG. 4 depicts a flow diagram illustrating the basic flow of a method for providing Multi-destination dynamic routing in logistics using the Multi-destination dynamic routing application System, according to the embodiments as disclosed herein;

FIG. 5 depicts a flow diagram illustrating the basic flow of a method for Multi-destination dynamic routing in logistics using Short Message Service (SMS) based communication in low network zones or poor connectivity zones, according to the embodiments as disclosed herein;

FIG. 6 depicts an exemplary screenshot of a User palm while accessing navigation view using a touch less gesture recognition method, according to the embodiments as disclosed herein;

FIGS. 7a and 7b depict an exemplary view of measuring Road-Bump hazard detection using the Multi-destination dynamic routing application System, according to the embodiments as disclosed herein; and

FIG. 8 is a block diagram of a machine in the example form of a computer system within which instructions for causing the machine to perform any one or more of the methodologies discussed herein may be executed.

### DETAILED DESCRIPTION OF INVENTION

The multi-destination dynamic routing application system 100 which provides multi-destination dynamic routing and optimal route plan in logistics as explained in the following detailed description is intended to provide example implementations to one of ordinary skill in the art, and is not intended to limit the invention to the explicit disclosure, as one of ordinary skill in the art will understand that variations can be substituted that are within the scope of the invention as described.

Throughout the specification, the terms, ‘Route’ and ‘Road’ are used interchangeably which also applies to the terms ‘User’ and ‘Driver’. The term ‘User’ generally refers to a person using the multi-destination dynamic routing application and includes the driver of the vehicle. Similarly, throughout the specification, the terms ‘multi-destination dynamic routing application system’, ‘system’ and ‘method’ are used interchangeably which also applies to the terms multi-destination dynamic routing application and application 110.

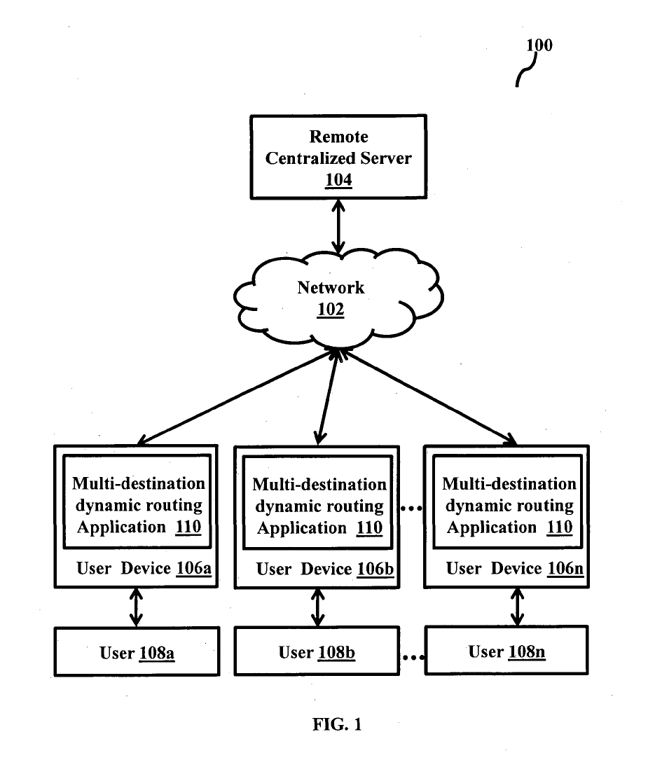

FIG. 1 is a block diagram of the multi-destination dynamic routing application system 100, according to the embodiments as disclosed herein. As depicted in the FIG. 1, the multi-destination dynamic routing application system 100 is a system for optimal transportation of product and people across multiple locations situated within a geographical area. The said system 100 comprises of a network 102, a remote centralized server 104, one or more user devices 106a . . . n having a mobile application (herein after referred as user device 106), one or more Users 108a . . . n (herein after referred as User 108) and a multi-destination dynamic routing application 110. The multi-destination dynamic routing application system 100 synchronizes the user device 106 with the remote centralized server 104 by establishing communication between the user device 106 and the remote centralized server 104 through the network 102.

At the beginning of the work-day the User (driver) of a delivery vehicle logs in and synchronizes his device 106 with the system 100 to authenticate the user device 106 with the remote centralized server 104. Synchronizing further provides the User(s) 108 a means for feeding inputs of current and destination locations, custom drops (new emergency product delivery), emergency alerts, traffic updation including traffic diversions and recent road constructions through the user device 106a. Once the user device 106 is synchronized with the system 100, the User(s) 108 will be enabled with the features of managing other users, changing user settings, downloading route, directions, destination route maps, next plan points, user tasks and priorities.

Next plan points generally refer to user tasks that are required to be performed at the completion of previous tasks as per the distribution order of the generated route map for delivery of product or people. Managing other users is typically performed by the manager (one among the User) of the vehicle fleet to track the vehicle and the user devices in real time for allocating new resources including co-coordinating either the pickup or delivery of product or people among the vehicle drivers. Changing user settings is the selection by the User of appropriate functionalities in the multi-destination dynamic routing application to suit the tasks required to be performed by the User. Downloading route maps and user tasks or priorities is either downloading of route maps or downloading revised route maps in case of new destination selection by the User together with the delivery or pickup tasks (product and/or people) that requires to be performed by the specific User (driver) at the appropriate time and location. The priorities are immediate tasks that are required to be performed by the User upon appropriate directions of the Manager of the fleet and/or custom choice of the User depending on situations and delivery schedules. The priorities are decided on the basis of destination classification, age of order, size of order, delivery windows, destination preferences and previous task completion history.

By using the System 100, the User 108 can add custom drops and re-route when he desires. Custom drops refer to tasks, for example delivery of product or people that may not reflect in the downloaded data when the User logs into application 110 for the day after synchronizing with the remote centralized server 104. Days custom drops may arise when the User finds an emergency pick-up and/or drop of a deliverable i.e., a product and/or people that needs to be taken care of immediately for the day. The days custom drops is particularly useful in the case of last-minute additions or changes to route plans, which do not require a complete optimal route planning.

Further embodiments of the system 100 provide the User 108 the option for out-of-turn deliveries for destinations and once the out of turn delivery is completed, the User 108 can resume where he left his original route. Out-of-turn delivery arises in case of custom drops where the User/driver needs to deviate the original route to accomplish a task of emergency pick-up or delivery for locations outside his original route. At times the locations may also be in the neighborhood of the original route but which may require a route deviation of the original route. The system 100, by using the remote centralized server 104, also ensures complete re-routing of the routes based on completed stops and remaining stops.

In certain embodiments, the multi-destination dynamic routing application 110 may be downloaded by end Users for installation and/or execution on the user device 106. In certain other embodiments, the multi-destination dynamic routing application 110 may be downloaded from the development platform or a third-party application hosting service.

In an embodiment, the remote centralized server 104 may have any suitable hardware or software configuration, or combination of hardware and software that is configured to generate a route, process route information, manages the user device or receives information from a vehicle associated with the User 108. In another embodiment, the remote centralized server 104 comprises of one or more route applications and one or more coordinate databases. For example, route applications may be any suitable software application for generating route information or otherwise processing route information. Coordinate databases may be any suitable databases for storing route information, such as location coordinates.

In an embodiment, the remote centralized server 104 is configured to remotely manage all the Users that are currently connected to it through the network 102. The Users 108 may be in continuous or discontinuous motion and can be seen in real time, with appropriate track points, on a map associated with the remote centralized server 104. Further, the User, who is accessing the map, can view route and delivery progress, next plan points and also communicate with all the connected Users using available options such as short messaging service (SMS) or Email or Chat based applications. Delivery progress may include the delivery status of other Users along the same route or a different route co-ordinated to complete the task for an optimal delivery.

In certain embodiments, remote centralized server 104 may be hosted and operated by one or more third-party service providers and/or may be accessed by developers through network using a developer computer. In certain embodiments, network 102 may be any suitable type of wireless network such as an internet or dedicated network that allows developers to access the multi-destination dynamic routing application system 100 through developer computer.

The network 102 represents the communication pathways among the remote centralized server 104, and user device 106. For example, the User 108 communicates with the remote centralized server 104 through the network 102. In an embodiment, the network 102 can be a wireless network, public network such as the Internet, private network, General Packet Radio Network (GPRS), Local Area Network (LAN), Wide Area Network (WAN), Metropolitan Area Network (MAN), cellular network, Public Switched Telephone Network (PSTN), personal area network, and the like. For example, the network 102 can be operable with cellular networks, Wi-Fi networks, or any other networks or combination thereof.

The network 102 may also utilize dedicated or private communications links that are not necessarily part of the Internet. In an embodiment, the network 102 uses standard communications technologies and/or protocols such as Multiprotocol Label Switching (MPLS), Transmission Control Protocol/Internet Protocol (TCP/IP), Hypertext Transport Protocol (HTTP), Simple Mail Transfer Protocol (SMTP), File Transfer Protocol (FTP), Short Message Service (SMS) protocol, and so on.

The data exchanged over the network 102 may be represented using technologies and/or formats including the HTML, the Extensible Markup Language (XML), the Extensible Hypertext Markup Language (XHTML), the compact HTML (cHTML), and the like. In addition, all or some of links can be encrypted using conventional encryption technologies such as, but not limited to the Secure Sockets Layer (SSL), HTTP over SSL (HTTPS), and/or Virtual Private Networks (VPNs).

In an embodiment, the multi-destination dynamic routing application system 100 may be operably connected with (or included within) an enterprise network. The Enterprise network may further include one or more of email or exchange servers, enterprise application servers, internal application store servers, authentication (AAA) servers, directory servers, Virtual Private Network (VPN)/SSL gateways, firewalls, among other servers and components. Email or exchange servers may include Exchange Active Sync (EAS) or other functionality that provides synchronization of contacts, calendars, tasks, and email between Active sync enabled servers and a user device 106. The user device 106 may access or utilize one or more of these enterprise systems or associated functionality.

The user device 106 may include a mobile computing device or any other portable device. For example, the mobile computing device can be a mobile telephone, laptop, tablet, computing pad, net book and the like. In an embodiment, the user device 106 stores program instructions that are executable to implement a browser program for displaying web pages (those hosted by system 100).

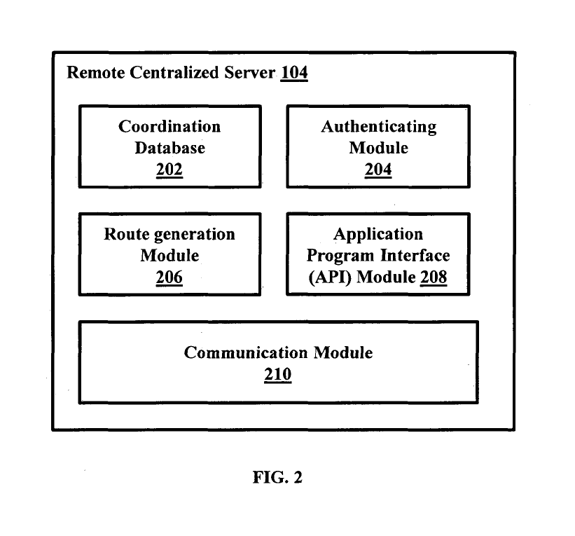

FIG. 2 is a block diagram depicting the modules in the remote centralized server 104 associated with the multi-destination dynamic routing application system 100, according to the embodiments as disclosed herein. As depicted in the FIG. 2, the modules in the remote centralized server 104 include a Coordination Database 202, an Authentication Module 204, a Route generation Module 206, an Application Program Interface (API) Module 208, and a Communication Module 210.

The Coordinate Database 202 stores all the relevant information associated with all aspects of the present subject matter. For example, the Coordinate Database 202 stores the information related to location coordinates of variety of locations. In an embodiment, the Coordination database 202 also stores the details and other secure information of all the Users 108 who have registered or logged on the multi-destination dynamic routing application system 100. For example, the details can be user login information, user previous history, user preferences and so on. In an embodiment, the Coordinate Database 202 may be any suitable databases for storing such location coordinates as latitude and longitude of a variety of locations. These locations may be, for example ‘points of interest (POI)’. Points of Interest (POI) refers to neighbourhood locations that may be of interest to the User enroute the destination and includes current or destination locations. Examples of POI includes: shops, commercial establishments, fuelling centres, super market, hotels, campsite, bus stands, railway stations, Government complexes, offices, public utility centres, parks, shipyard, theatres, warehouses, lakes, service centres and the like.

Coordinate Database 202 may also be a database of street addresses or routes between various source and destination points. In particular embodiments, Coordinate Database 202 includes mass storage for data or instructions. As an example and not by way of limitation, storage may include a Hard Disk Drive (HDD), a floppy disk drive, flash memory, an optical disc, a magneto-optical disc, magnetic tape, or a Universal Serial Bus (USB) drive or a combination of two or more of these. Storage may include removable or non-removable (or fixed) media and may be internal or external to computer system, where appropriate. In particular embodiments, storage is non-volatile, solid-state memory. In particular embodiments, storage includes read-only memory (ROM). Where appropriate, this ROM may be mask-programmed ROM, programmable ROM (PROM), erasable PROM (EPROM), flash memory or a combination of two or more of these. The Authentication module 204 can be configured to authenticate the login information provided by the User. The Authentication module 204 verifies the login information by using the data associated with the Coordination Database 202.

Once the User 108 inputs the information corresponding to source and destination locations, the Route generation module 206 calculates list of directions between the two locations. In an embodiment, the Route generation module 206 may include applications or suitable software or hardware programs for managing or calculating routes, portions of route or route coordinates. For example, the Route generation module 206 may calculate routes from navigation user's current location to private residences, businesses or recreational facilities. For example, the Route generation module 206 may generate routes by determining corresponding latitude and longitude values on an input navigation address. In an embodiment, the Route generation module 206 is in communication with the Coordinate Database 202.

The Application Programming Interface (API) Module 208 specifies how software components should interact with each other in the remote centralized server 104. The communication module 210 may include hardware, software, or both providing one or more interfaces for communication (such as, for example, packet-based communication) between the remote centralized server 104 and the user device 106. As an example and not by way of limitation, communication interface may include a network interface controller (NIC) for communicating on a wireless NIC (WNIC) such as a WI-FI network. This disclosure contemplates any suitable network and any suitable communication interface for it. As an example and not by way of limitation, system 100 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the System 100 may communicate with a wireless PAN (WPAN) (e.g., a BLUETOOTH WPAN), a WI-FI network (e.g., a 802.11a/b/g/n WI-FI network), a WI-MAX network, a cellular telephone network e.g., a Global System for Mobile Communications (GSM) network, a Long Term Evolution (LTE) network) or other suitable wireless network or a combination of two or more of these.

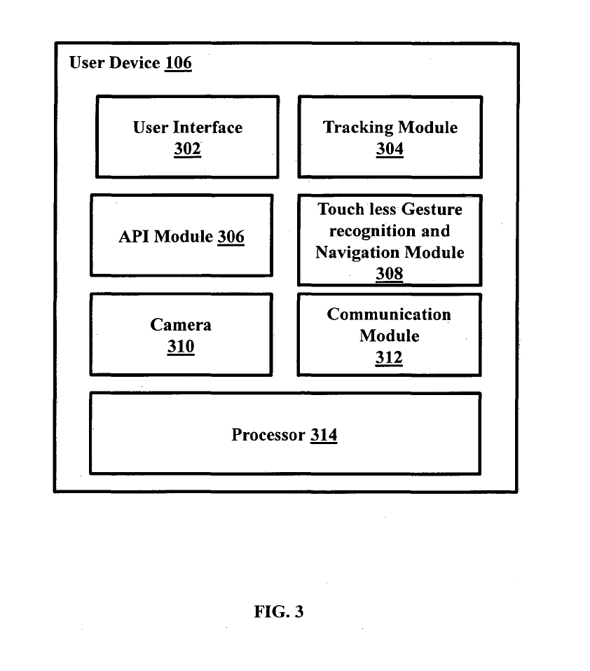

FIG. 3 is a block diagram depicting the modules in a User Device 106 associated with the multi-destination dynamic routing application system 100, according to the embodiments as disclosed herein. As depicted in the FIG. 3, the modules in the user device 106 include a User Interface Module 302, a Tracking Module 304, an API Module 306, a touch less Gesture recognition and Navigation Module 308, Camera 310, Communication Module 312, and a Processor 314.

The User Interface (UI) 302 comprises a display unit and an input means for receiving necessary input information from a User 108. The UI 302 also includes the screen menus and icons, keyboard shortcuts, gesture movements, command language and online help features. Further, the UI 302 may allow the User(s) 108 to access a variety of internet and communication network-based services in accordance with the present invention. For example, User 108 may access the remote centralized server 104 via this interface. In one embodiment of the invention, User(s) 108 connect to the remote centralized server 104 through the network 102 using standard Web browsers.

In particular embodiments, UI 302 includes hardware, software, or both providing one or more interfaces for communication between the remote centralized server 104 and the User 108. As an example and not by way of limitation, the input means of the user device 106 may include a keyboard, microphone, display, touch screen, touch less gesture recognition, mouse, speaker, camera, another suitable input/output (I/O) device or a combination of two or more of these. An I/O device may include one or more sensors. This disclosure contemplates any suitable I/O devices and any suitable I/O interfaces for them. Where appropriate, UI 302 may include one or more device or software drivers enabling processor to drive one or more of these I/O devices. Although this disclosure describes and illustrates a particular I/O interface, this disclosure contemplates any suitable UI.

At any point of time, when the User is online (with internet connectivity enabled) on the user device 106 and has downloaded the multi-destination dynamic routing application, the UI 302 allows the User to synchronize with the remote centralized server 104. The UI 302 then allows the User 108 to input necessary information corresponding to user current location and destination location in any of the suitable format such as by typing the text or through a voice command and so on. In an embodiment, the multi-destination dynamic routing application 110 may allow the User to select the source location and the destination location from the list of options displayed on the UI 302.

The Tracking module 304 is configured to track the route compliance of the User 108 in real time. In an embodiment, the Tracking module 304 provides a reason code screen that requires just a single touch by the User to record the real reason behind him deviating from his route. Further, the Tracking module 304 sends the feedback to the remote centralized server 104 as the reason behind non-compliance on the specific route of the User.

The API Module 306 specifies how software components should interact with each other in the user device 106. The Touch less Gesture recognition and Navigation Module 308 is configured to provide navigation, view of the generated route map by using a hardware button implementation method and gesture recognition method. The Camera 310 available in the user device 106 captures the palm of the User when placed in front of the camera, calibrates the current map view to the palm, and then traces the palm's movements and gestures to the Camera 310 perspective of the map view.

The communication module 312 may include hardware, software or both providing one or more interfaces for communication (such as, for example, packet-based communication) between the remote centralized server 104 and the user device 106. As an example and not by way of limitation, communication interface may include a network interface controller (NIC) or other wire-based network or a wireless NIC (WNIC) for communicating with a wireless network, such as a WI-FI network. This disclosure contemplates any suitable network and any suitable communication interface for it. As an example and not by way of limitation, system 100 may communicate with an ad hoc network, a personal area network (PAN), a local area network (LAN), a wide area network (WAN), a metropolitan area network (MAN) or one or more portions of the internet or a combination of two or more of these. One or more portions of one or more of these networks may be wired or wireless. As an example, the System 100 may communicate with a wireless PAN (WPAN) (e.g., a BLUETOOTH WPAN), a WI-FI network (e.g., a 802.11a/b/g/n WI-FI network), a WI-MAX network, a cellular telephone network (e.g., a Global System for Mobile Communications (GSM) network, a Long Term Evolution (LTE) network) or other suitable wireless network or a combination of two or more of these.

The user-side functionality described above may be implemented as a series of instructions stored on a computer-readable storage medium that when executed, makes a programmable processor to implement the operations described above. The user device 106 may be implemented in a variety of different hardware and computing systems.

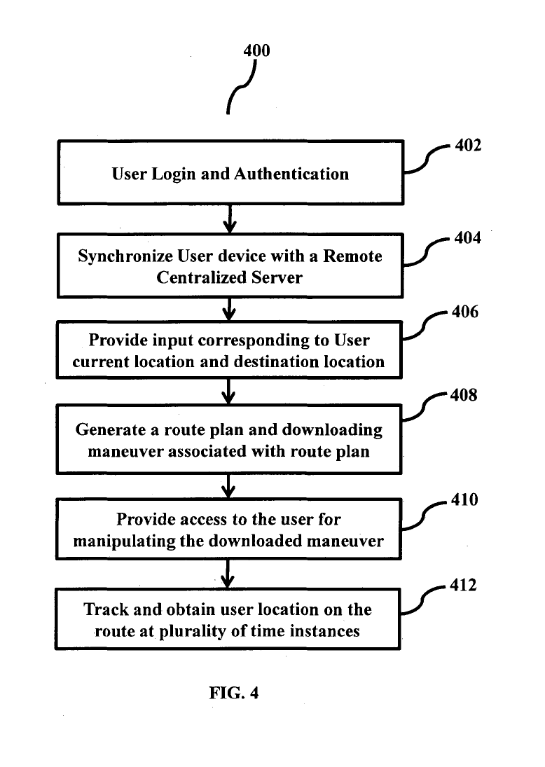

FIG. 4 depicts a flow diagram illustrating the basic flow 400 of a method for providing multi-destination dynamic routing in logistics using the multi-destination dynamic routing application system 100, according to the embodiments as disclosed herein. At step 402, log in information and other desired credentials are obtained from a User 108 through UI 302 of the user device 106. Further, the log in information is authenticated. Authentication is the process of confirming the identity of a User. Authentication can include but not be limited to HTTP basic authentication, Form-based login authentication, client certificate authentication, mutual authentication and digest authentication. Later, a check is performed to ascertain if verification was successful. If verification is considered successful, access is provided to the User to access the remote centralized server 104. In case verification is not successful, the remote centralized server 104 redirects the User 108 to the log in page where the User 108 can input correct login information.

At step 404, the user device 106 is synchronized with the remote centralized server 104. In an embodiment, the synchronization may be done by establishing communication between the user device 106 and the remote centralized server 104 wherein, the User (driver) of a delivery vehicle logs in and synchronizes his device 106 with the System 100 at the beginning of the work-day to download all the route, directions, destination route map, delivery progress, next plan points, User tasks, priorities and further synchronization by the User by feeding inputs, managing other users, changing user settings and downloading routes, user tasks or priorities. The Coordination Database 202 synchronizes the user device 106 with the remote centralized server 104 by sending communication links through the Communication Module 210. In an embodiment, the synchronization may include accessing the user device 106 identity for tracking and determining user services and preferences.

At step 406, the User 108 provides input corresponding to user current location and destination location through the UI 302. In an embodiment, the remote centralized server 104 may determine user's current location through the use of a global positioning system associated with the user device 106. The User 108 may then input the remote centralized server 104, with a destination location and request a route to reach the destination.

After obtaining the user's current location and destination location information, at step 408, the route generation module 206 generates an optimal multi-destination route plan and communicates the generated multi-destination route map to the User 108 through his user device 106. Further, the User 108 can download one or more maneuvers associated with the generated multi-destination route plan. In an embodiment, at any point of time, the User 108 can download full or a part of the generated multi-destination route plan from the remote centralized server 104 into his user device 106.

In an embodiment, the route generation module 206 generates an optimal route plan by giving priorities to the destinations so that higher priority destinations can be covered first by the User 108. The priorities are decided on the basis of destination classification, age of order, size of order, delivery windows, destination preferences and previous task completion history.

Once the User 108 downloads the map, at step 410, the remote centralized server 104 is configured to provide access to the User 108 for manipulating the map. In an embodiment, the User 108 can access the navigation view by using a unique hardware button implementation method. In this method, the User 108 can press the volume down button on the map view to access the navigation view of the generated route. This method further provides a quick view of the neighboring designations, User Point of Interests (POIs), current direction of the User 108 movement and so on. The User 108 can press the volume down button for a longer duration to begin the directions playback function of the application 110, which provides a complete voice-guided step by step directions overview of the remaining route. Similarly, the User can access or view a 3-dimentional map of the generated route by pressing the volume down button. This is facilitated in the manager application, a menu within the application for accessing and co-ordinating other Users in real time. In an embodiment, pressing volume up button toggles and scrolls between all tracked Users one after the other.

In another embodiment, the User 108 can access the navigation view by using a gesture recognition method without requiring touching the screen or pinching the screen to zoom in or out of the map. The front camera available in the user device 106 captures the palm of the User 108 and calibrates the current map view to the palm, and then traces the palm's movements and gestures to the camera perspective of the map view. The following are the various navigation features and corresponding User's palm movements that can be accessed by using the touch less Gesture recognition method:
User 108 can move his or her palm towards the screen to zoom into the map
User 108 can move his or her palm away from the screen to zoom out of the map
User 108 can rotate his or her palm in either clockwise or anti-clockwise direction to rotate the map in respective direction. Keeping the palm rotated for a long duration continues to rotate the map in the same direction until the User resets his palm to original reference point.
User 108 can tilt his palm forwards at the finger edges, to pan the camera view of the map, so that the map becomes flatter and greater geography in the direction of the vehicle is visible to the driver.
User 108 can tilt his palm backwards at the finger edges, to pan the camera view of the map, so that the map loses perspective and greater geography all-around the vehicle is visible to the driver.
User 108 can move his palm to the left side in an air-swipe like movement to bring the destinations view, and swipes his palm to the right side when in the destinations view in order to go back to the map view.
User 108 can close palm to indicate that the map view is as desired and to stop tracking the User's palm.
User 108 can close palm twice in quick succession to indicate that the map view is not as desired and to reset the map view to the initial state when the User began the hands-off session.

At step 412, the Tracking Module 304 may begin to navigate the route by following the route map instruction provided to the User 108. Further, the Tracking Module 304 communicates the real time position of the User 108 through the Communication Module 312. In an embodiment, the Tracking Module 304 may or may not be in continuous communication with the remote centralized server 104 while navigating throughout the entire route. In such case, the Tracking Module 304 may send the location information periodically to the remote centralized server 104 for monitoring the progress along the route. The various actions in method 400 may be performed in the order presented, in a different order or simultaneously. Further, in some embodiments, some actions listed in FIG. 4 may be omitted.

In addition to the above embodiments associated with multi-destination dynamic routing further embodiments provide a method for optimal delivery in logistics using a metric called clustering wherein clustering is combining closely located destinations for same deliveries using same vehicle only if the located destinations are both large such that they attract each other towards a central point.

Two groups containing a finite number of closely located destinations are combined provided they satisfy the condition of minimum or maximum number of destinations deliverable by a driver. Similarity of the clusters based on the type of deliveries is factored into the minimum distance threshold for combination of clusters, such that similar clusters are more likely to be combined compared to dissimilar clusters.

The clustering is prioritized for planning logistics delivery including distance priority mix for consideration in clustering: In order to give weightage to both: priority and distance, the values in distance score matrix are changed from mere distances to a variation of Distance*Priority, which is governed by the following formula as explained below:

Balanced: distance*priority, Priority oriented: (d*pd′)(1+0.1*(Pd′−Ps′))

Formula for GPS: (d*pd′)(1+0.1*(Pd′−Ps′))

Where, d=rectilinear distance between the source and destination, Pd=Priority of destination
Pd′=Priority of destination/μ
Ps=Priority of source
Ps′=Priority of source/μ
μ=priority number of most important point among all the drops
Note: priority may be chosen to be rank Ordered (1 being the most important, 2 being lesser important than 1 and so on . . . ) or value-Based (drop with priority 100 being 20 times more important than a 5-value drop) Users are provided with a knob of 3 algorithms i.e., pure distance based (greedy), balance between priority and distance, more importance to priority.

Drop Priority is constituted of a number of drop-specific parameters such as sales or order value, sales weight, days old, customer loyalty, locality index (urbanity), morning traffic, evening traffic, and so on. In this way, out of several drop-clusters in an area, only few close ones are picked up for combined deliveries on the basis of this clustering.

In the multi-destination dynamic routing, Priority clustering may be activated by the User's appropriate input in the user device through the user interface 302 effectively communicated to the remote centralized server 104 via communication module 312. The received input is authenticated by the remote centralized server 104 and then route generation module 206 generates the required clustering data based on information available in the co-ordination database 202 which is then communicated to the user device via the communication module 210.

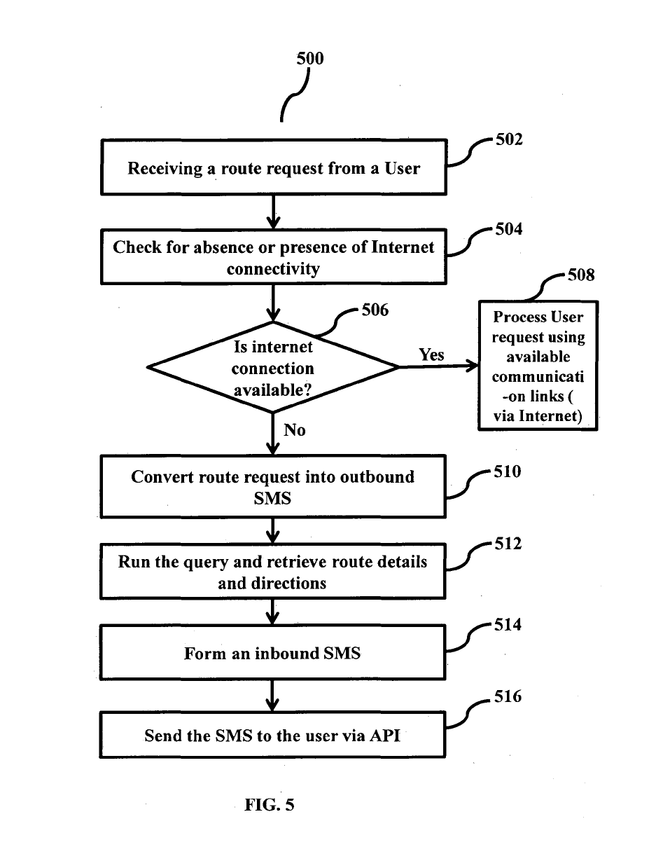

FIG. 5 depicts a flow diagram 500 illustrating the basic flow of a method for multi-destination dynamic routing in logistics using Short Messaging Service (SMS) based communication in low network zones or poor connectivity zones, according to the embodiments as disclosed herein. At step 502, the method 500 includes receiving a route request from the User 108. As discussed earlier, the User can send a route request to the remote centralized server 104 by providing the input information corresponding to user's current location and destination location. At step 504, the remote centralized server 104 checks for absence or presence of internet connectivity of the user device 106. At step 506, if the remote centralized server 104 determines proper internet connectivity to the user device 106, then the User request is processed using normal communication links, as described in FIG. 4. At step 506, if the remote centralized server 104 determines that there is poor connectivity or user device 106 is in low network zone, then SMS based communication is used to process the User 108 request. At step 510, the method 500 includes converting the route request into an outbound SMS by using the Communication Module 210. Later, at step 512, the remote centralized server 104 runs the query and generates route details and directions using the route generation module 206. Further, at step 514, the Communication Module 210 forms an inbound SMS and send the SMS to the user device 106. In an embodiment, the remote centralized server 104 interprets received SMS for providing emergency routing service to the User 108. The various actions in method 500 may be performed in the order presented, in a different order or simultaneously. Further, in some embodiments, some actions listed in FIG. 5 may be omitted.

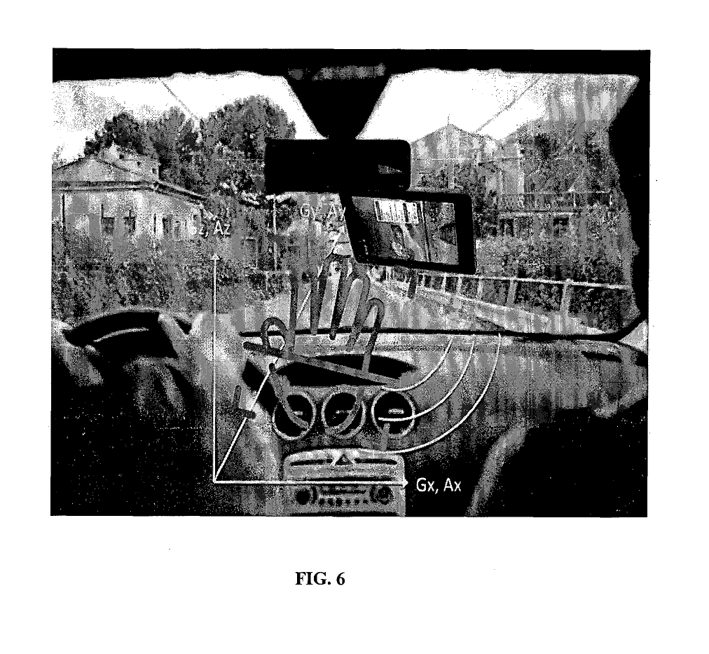

FIG. 6 is a schematic diagram depicting an exemplary screenshot of a User palm while accessing navigation view using a touch less gesture recognition method, according to the embodiments as disclosed herein. As depicted in the FIG. 6, the User's 108 palms move with the vehicle's movements, which in turn is in sync with the user device 106, as the user device 106 is preferably transfixed to the vehicle dashboard or windscreen. This allows the User 108 to navigate and view the various places around the User 108 using a hands-off and eyes-off technique that is comparatively less sensitive to the device-vehicle-user movements, as well as significantly safer as the User 108 need not be bothered about the hand-eye coordination aspects involved in operating the user device 106 while driving.

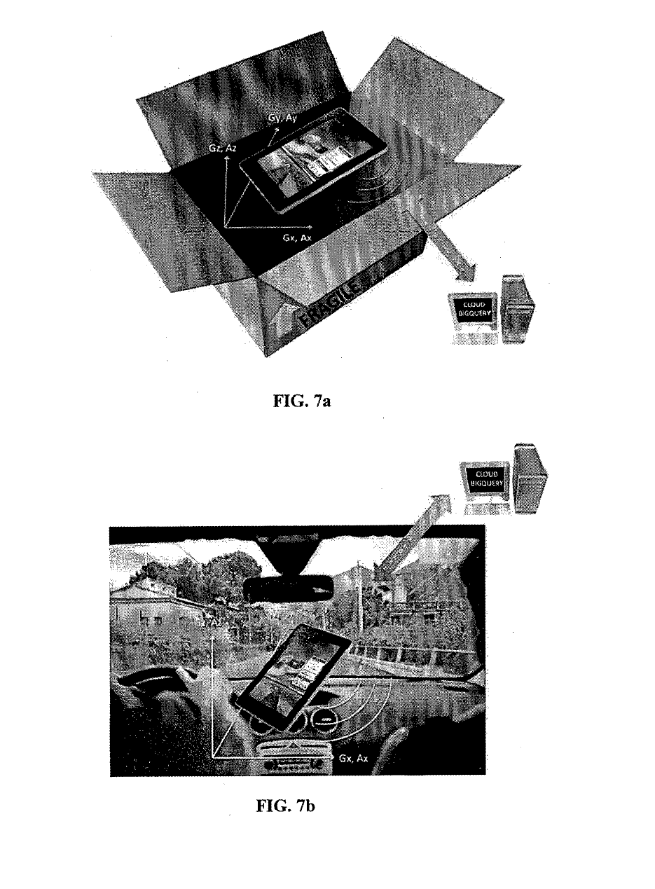

FIGS. 7a and 7b depict an exemplary view of measuring road bump-hazard detection using the multi-destination dynamic routing application System, according to the embodiments as disclosed herein.

In an embodiment, the Tracking Module 304 of the user device 106 identifies route irregularities including bumps while the User 108 is moving from the current location to the destination location. The Tracking Module 304 may process the accelerometer readings of the User vehicle for identifying the route regularities. Further, the user device 106 frequently updates the identified irregularities to the Coordination database 202 of the remote centralized server 104 by using the Communication Module 312. After receiving the updated data, the Authentication Module 204 performs a check to determine whether the received data is valid. Once confirmed to be valid records, the Communication Module 210 sends the information to all other Users 108 of the system 100 so that the other Users 108 are suitably forewarned of impending poor-quality roads ahead on their way. In an embodiment, these warnings may be shown to the Users 108 by using a visual cue such as “Slow Down” or “Speed Up”—this is an ideal speed range indicator for the vehicle concerned, taking into factor the quality of the road, the traffic and prevalent speed on those roads and contents of the goods being delivered.

The road bump detection is accomplished in the multi-destination dynamic routing application system 100 as described below: Stage I algorithm:

The road bump detection algorithm Stage I begins with low pass filtering applied to the User device 106 accelerometer readings which separates out the continuous vehicle movements from the device movements and thereby the continuous speed movement acceleration vectors associated with vehicle movement component. The remaining component consists of sudden vehicle movements and sudden device movements, which are then split into the 3-dimensional components along the direction of gravity (handling for device orientation at rest) and direction of movement of the vehicle. These are uploaded to the cloud backend, where Stage II algorithm further processes these points to split into global patterns and driver specific observations based on certain rules:

### Part (1): Obtaining the Actual Values of Horizontal and Vertical Acceleration

(a) using gx, gy, gz to obtain g vector
(b) rotate all the three axis along the g vector such that the new z axis will now be along the direction of gravity. Thus the acceleration along the new z axis will give actual vertical shift and the one along new x axis will give actual horizontal shift.
This is on php script to generate actual acceleration along three direction before uploading to data table (new values: aX, aY, aZ).
Default bump intensity for unprocessed data is uploaded as zero here.

### Stage II Algorithm:

### Part (2): Finding Bump Intensity

Loop Start:
(a) get unprocessed record(lat,long, timestamp, bearing) from table
(one record where flag=0 and intensity = 0)
(b) get all the records within the 10 meters of the current Location,
within 1 sec of current time, within (+−)45 degree of current bearing
(all the reading for single direction comes within this range), ABS(aZ) >
threshold and for same route identity (getting and data for a single bump)
Potential bump: where ABS(aZ) > threshold; This optimum threshold
value to be decided
(1) Intensity = number of entries where aZ > 0
(2) Append this to the intensity of all the records found above

end

end

Here assumption is: user device is attached to the vehicle and not on an oscillating stand. This bump intensity function will work sub-optimally if the user device oscillates, unless this oscillation is identified and compensated for through second order algorithms.

### Stage III Algorithm:

Loop Start:
(a) get unprocessed record(lat,long, bearing) from table (one record where flag=0)
(b) recordCount = get all the records within the 10 meters of the current Location
where bearing is (+−)45 degree of current bearing

if recordCount > 10 (for actual bump, number of readings uploaded by a

| | |
|---|---|
| single bump > 5) | i] totalcount = recordCount |

ii] route_count = unique route_id from result ( a )
iii] avg_lat = SUM(latitude)/totalcount
iv] avg_long = SUM(longitude)/totalcount
v] intensity_avg = SUM(intensity)/totalcount

vi] confidence = (route_count (where confidence return is 1)) − (

route_count(where confidance return is −1)) // −1 confidance is returned when bump
is not detected for the same location

if confidence > 3 // confidence level of the bump

update table with flag=1 (which will denote the processed entries)
populate google big query table with the resultant bump (b)
Populate timestamp of the time of this clustering in all the data

// to be used for periodic cleaning

else

break

END : if

else
stop ∥ break loop
END : if

END : Loop

For showing bumps on map, show bumps which are within (+/−) 45 degrees of the current direction of motion (route).
Present a-x components as belonging to bumps, side-swerves or brakes/acceleration events. Ay components are correlated strongly to ‘az’ components suggesting that brakes are often accompanying vertical impact to the vehicle or the device. Ax or side-swerve components are common in case of sudden steering movements or side impact, suggesting rash steering control which is common in drunken driving cases. This is useful in generating a unique drunken driving indication for the ride.
Part (4): Periodic Cleaning of Bump Table from Big Query

(a) Download all entries where flag = 1
(b) make flag = 0 for all
(c) loop start:

(1) get unprocessed record (lat, long, bearing) from table (one record

where flag=0)

(2) recordCount = get all the records within the 10 meters of the

currentLocation where bearing is (+/−) 45 degree of current bearing

if recordCount > 2 (atleast 2 entries for same bump)

i] totalcount = recordCount
v] intensity_avg = SUM(intensity)/totalcount
vi] confidence = SUM(confidence)/totalcount

Only a percentage of the confidance to be used for oldest reading and actual
confidance for newest reading

| | |
|---|---|
| if confidence > 3 | // confidence level of the bump |

update table with flag=1 (which will denote the processed entries)
populate google big query table with the resultant bump (b)

else

break

END : if

else

stop ∥ break loop

END : if

END : Loop

The multi-destination dynamic routing application 110 sends request to the remote centralized server 104 with current or expected location and the remote centralized server 104 queries and retrieves all bump locations and computed parameters and sends it back to the application 110. There is a measurable latency in this loop which is measured and factored into the location estimate.

Location queries are intelligently sent from the multi-destination dynamic routing application, using a linear interpolator based on past few tracks and current route to predict the next likely location, given existing speed, so that the retrieved bumps are relevant to the driver at that point. Every location query from the application 110 picks only relevant bumps from the filtered bumps set and sends back road quality, confidence, bump uniqueness, and recommended speed for interpretation and presentation by the application 110.

The user device 106 running the application 110 may be affixed to car windshield in a manner that its rear-camera is facing the road ahead. Since the application retrieves past reported bumps and knows when a vehicle is headed into such bumps, the user device 106 rear camera is used to snap photographs of the bumps which is used to further validate and strengthen the online road hazard database, and to crowd-source and share this information with other Users. Advantages of the above discussed features are:
Comparing the particular route's observations versus the universal readings for the route and querying for differences points out either: Good driving where the driver has been able to carefully avoid road hazard events that others have been recording or ill driving when the driver has recorded road hazard events even where others have managed to avoid these events.
Ride quality index—this computation uses Big Data in order to factor in multiple parameters such as universal road hazards, en route bumps, over speeding, as well as in-package bump detection (if available) in order to provide a ride quality rating for each concluded route or leg. This report provides similar alerts to the driver who can take corrective action to fix the ride quality on the go.

### In-Package Bump Detection:

The user device 106 when firmly attached within the sealed package is useful as a measure of bumps that the other package contents are being subjected to. This is especially critical in case of fragile goods deliveries. The consolidated report is useful as a final measure of physical damage subjected to the goods enroute, and also serves as a real-time damage indicator which can be either centrally tracked or tracked from within the vehicle by the driver through his mobile application which is coupled to these in-package units. This allows the driver to be alerted as soon as the goods undergo bumps or jerks so that he can take corrective action and make changes to route, package layout or arrangement to ensure minimal damages in rest of the route.

### Hand-Held Bump Detection:

The algorithm is also capable of detecting when the user device is not attached to the vehicle, but rather in constant motion (when the low pass filtered output is changing significantly with time) due to human engagement, and accordingly can track the number and intensity of bumps that these devices are being subjected to. This is very handy in enterprise deployments or household use-cases e.g., when device provided to children, where specific device misuse cases can be centrally highlighted and corrective action can be taken, not limited to device usage withdrawal from the User.

In another embodiment, the remote centralized server 104 allows the Users 108 of the multi-destination dynamic routing application system 100 to access and view the remaining or alternate driving directions in a visual manner, almost as the crow files. Along with the 3-Dimensional projection view of the map, as discussed earlier using hardware button implementation method, this presents almost a route fly-by view of the route remaining. This can be referred to as ‘Traditional’ driving directions, as most of the Users prefer to give directions in this manner. This poses a high benefit to the developing market, where traditional drivers are not comfortable with turn-by-turn navigation, viewing them with doubt due to the inherent opacity of the directions involved.

In another embodiment, the multi-destination dynamic routing application system 100 provides information capture for route compliance as well as non-compliance by tracking routes in real-time. The multi-destination dynamic routing application system 100 tracks route compliance in real-time by using the Tracking Module 304 and brings up a reason code screen that requires just a single touch by the User 108 to record the real reason behind deviating from User's original route. Further, the data is fed back to the remote centralized server 104 as the reason behind non-compliance on the specific route and is processed with other User 108 inputs to interpret the reason and adjust routes accordingly. Routes are then adjusted next time by adding newer waypoints avoiding the obstructed routes.

In another embodiment, the system 100 provides a means of accessing route and directions information in the absence of active internet connection. While the entire application can be operated with no internet connectivity, any changes to planned routes usually require internet connection. The system 100 also provides a means of communicating with the remote centralized server 104 using SMS protocol, where requests and short directions can be transferred using SMS.

In another embodiment, the system 100 utilizes User's 108 task completion times, and cues from Big Data Analysis on their check-in and check-outs at destinations as a source of parking information. This further ensures when the parking spots are freed up in the real time. For example, a car parked for a significant period indicates the presence of a likely approved parking spot. When this car starts moving away from this parking spot, this reflects as a dynamic parking spot being freed in any application User's 108 map happening to be in the neighborhood.

In another embodiment, the multi-destination dynamic routing system 100 does not repeat the capturing reason codes, reports, and updating feeds to the remote centralized server 104. For example, whenever the User 108 re-routes or follows a different path, a prompt appears on screen requesting for reason for deviation with 9-10 reasons. These reason codes are analyzed for location patterns in BigQuery backend in a similar fashion as the bumps filtering, where reason or bearing pairs are clustered and given a confidence level based on overall percent of Users reporting the same. This is then fed into the Route generation Module 206, which modifies the source location and destination locations by adding nearby known safe waypoints for each affected leg, in loop until the returned routes avoid the known road hazards.

In another embodiment, the multi-destination dynamic routing application system 100 queries for all points of interests (POIs) tagged as Fuel or Fueling points in a given radius whenever the driver 108 stops the vehicle. The User 108 can log in his fuel details including money spent and fuel refilled at the fuel point that driver is within geo-boundaries. This acts as proof of refueling, and together with his distance and time travelled, helps in the overall expense accounting for the drivers daily routes. This also helps throw driver intelligent reminders for refueling given his live routes or legs and nearest fuelling points. In another embodiment, fuel sensing step is automated which help further may optimize the weight of fuel-cargo ratio and boost the fuel economy by a fraction, which over the years yields benefits to enterprise Users.

In another embodiment driving directions are parsed and split into common nouns (names of POIs), prepositions and actual directions, using an intelligent string processing algorithm that understands the grammar of the returned directions and converts individual parts and then stitches them together. The actual directions are then converted into any language using phonetic translation into English language, so that even a basic English language Text to Speech (TTS) can read out directions in native language of User's choice.

The translator can be refined easily without the need to download complex audio files, and additions of other native languages can be done seamlessly. This further reduces software size, processing time & effort, while making it universally available on all user devices, without the need to install additional speech data.

### A Sample Translation Script for English—Hindi Translation:

if (root.data.trim( ).equalsIgnoreCase(“toward”))

append = “ key tarruff”;

| | |
|---|---|
| else | if |

(root.data.trim( ).equalsIgnoreCase(“pass by”))

append = “ paar curry yay”;

| | |
|---|---|
| else | if |

(root.data.trim( ).equalsIgnoreCase(“onto”)

||

root.data.trim( ).equalsIgnoreCase(“at”)

||

root.data.trim( ).equalsIgnoreCase(“on”))

append = “ pay”;

| | |
|---|---|
| else | if |

(root.data.trim( ).equalsIgnoreCase(“take”)

||

root.data.trim( ).equalsIgnoreCase(“make”))

append = “ lay”;

| | |
|---|---|
| else | if |

(root.data.trim( ).equalsIgnoreCase(“to”))

append = “ K lee-yay”;

| | |
|---|---|
| else | if |

(root.data.trim( ).equalsIgnoreCase(“merge”))

append = “ millnay”;

| | |
|---|---|
| else | if |

(root.data.trim( ).equalsIgnoreCase(“continue onto”))

append = “ pay bunnay rahay”;

| | |
|---|---|
| else | if |

(root.data.trim( ).equalsIgnoreCase(“drive along”))

append = “ pay bunnay rahay”;

| | |
|---|---|
| else | if |

(root.data.trim( ).equalsIgnoreCase(“after”))

append = “ K bard”;

| | |
|---|---|
| else | if |

(root.data.trim( ).equalsIgnoreCase(“turn left”)

||

root.data.trim( ).equalsIgnoreCase(“slight left”))

append = “ bye moody yay”;

| | |
|---|---|
| else | if |

(root.data.trim( ).equalsIgnoreCase(“turn right”)

||

root.data.trim( ).equalsIgnoreCase(“slight right”))

append = “ die moody yay”;

| | |
|---|---|
| else | if |

(root.data.trim( ).equalsIgnoreCase(“keep right”))

append = “ die oar, bunnay rahay”;

| | |
|---|---|
| else | if |

(root.data.trim( ).equalsIgnoreCase(“keep left”))

append = “ bye oar, bunnay rahay”;

| | |
|---|---|
| else | if |

(root.data.trim( ).equalsIgnoreCase(“stay”))

append = “ reHnay”;

| | |
|---|---|
| else | if |

(root.data.trim( ).equalsIgnoreCase(“continue”))

append = “ bunnay rahay”;

| | |
|---|---|
| else | if |

(root.data.trim( ).equalsIgnoreCase(“head southwest”))

append = “ dakshin paschim disha mai jaai

yay”;

| | |
|---|---|
| else | if |

(root.data.trim( ).equalsIgnoreCase(“head southeast”))

append = “ duckshin poorva dishaa may jaai

yay”;

| | |
|---|---|
| else | if |

(root.data.trim( ).equalsIgnoreCase(“head northwest”))

append = “ oot turf pus chim dishaa may

jaai yay”;

| | |
|---|---|
| else | if |

(root.data.trim( ).equalsIgnoreCase(“head northeast”))

append = “ oot turf poorva dishaa may jaai

yay”;

| | |
|---|---|
| else | if |

(root.data.trim( ).equalsIgnoreCase(“head south”))

append = “duckshin dishaa may jaai yay”;

| | |
|---|---|
| else | if |

(root.data.trim( ).equalsIgnoreCase(“head north”))

append = “ oot turf dishaa may jaai yay”;

| | |
|---|---|
| else | if |

(root.data.trim( ).equalsIgnoreCase(“head east”))

append = “ poorva dishaa may jaai yay”;

| | |
|---|---|
| else | if |

(root.data.trim( ).equalsIgnoreCase(“head west”))

append = “ pus chim dishaa may jaai yay”;

| | |
|---|---|
| else | if |

(root.data.trim( ).equalsIgnoreCase(“destination will
be”))

append = “ mun zil hogi”;

| | |
|---|---|
| else | if |

(root.data.trim( ).equalsIgnoreCase(“left”))

append = “ bye oar”;

| | |
|---|---|
| else | if |

(root.data.trim( ).equalsIgnoreCase(“right”))

append = “ die oar”;

In yet another embodiment the system 100 provides for real time SMS based location retrieval. As an example, let us consider that a Manager in Manager application menu is using the system 100 to track all his employees who are connected to the Network 102. Manager is able to see current location of his drivers if they are online. In case they are not online, manager can hard-request for current location, which sends a pre-formatted SMS to the driver, and the driver application senses this in real time and sends back an SMS with the precise current location. Manager then sees this User's location on the map.

### Real Time Drop Addition:

In another embodiment the Manager (one among the User) is able to access his entire drops list, select one, view it on a map and add it for a driver. This then becomes an ad-hoc drop SMS to the driver, which the driver can add and navigate to. The application automatically includes this drop and reroutes the rest of the drops.

### Real Time Package Tracking:

In yet another embodiment the Airway Bill (AWB) numbers are entered in the task details of drivers, and this is queried after User enters the AWB and requests real time tracking. The manager (one among the User) or a parcel customer (one among the User of the multi-destination dynamic routing application system) is able to enter the Airway Bill Number in manager application, and retrieve the real time location of the driver or vehicle carrying the specific package. This is then showed as the real time driver location and the delivery location on a map, along with estimated time remaining for delivery at the assigned location. The User i.e., a parcel customer (one among the User of the multi-destination dynamic routing application system) is also allowed to communicate with the driver.

In a preferred embodiment, the driver as well as manager application package (Android/iOS/BlackBerry OSs) will be hosted on a short link (gridb.in/$) and will be downloaded and installed at the client side on client devices. The application may also be downloaded and installed on device from 3P operated portals such as Play Store or Application Store, or through a software reseller. The application may be pre-packaged and installed in a hardware device with necessary attachments and accessories to affix it to client vehicle dashboard or windshield. The web application for Analytics and Project Management is cloud-hosted and completely supported and accessible from a secure web Universal Resource Locator (URL) on Personal Computer (PC) or mobile. The manager application can be accessed from the client's device or a PC web browser that simulates and supports mobile applications, and provides anywhere access on driver/vehicle route and whereabouts as well as location history to the client.

While providing additional functionality compared to any other navigation or location-based application, the application incorporates several feature controls such as tracking density or location listener interval, or road hazard detection radius which can be dynamically changed in the application through user settings to enhance battery efficiency. Additionally, the application design ensures that all of the destination and most of the map data required to operate throughout the day is downloaded during first login in the morning (which happens in office premises where device is charged, and hence, does not consume battery power). The application supports compression of track data based on a differential value encoding format, which sequences and compresses the extensive track data generated continuously as well as route, orientation and road hazard data by a factor of over 6-7 times, resulting in lesser memory, data and synchronizing (sync) time requirements, while ensuring 100% sync-rates even in case of accidental device shutdown, corruption or disruption in internet or backend services. The application 110 further supports audio playback of driving directions and use of external hardware buttons such as volume up or down buttons to control directions playback, which can be used by motorcycle or two-wheeler drivers to navigate keeping the device in a concealed area such as a bag or trouser/shirt pocket in locked condition. This turns off the display of the device, and ensures minimal power consumption, making the application even power-thrifty. This whole-day functionality ensures ease of use without the need to carry device chargers or power banks in enterprise use-cases.

In one embodiment, the application 110 supports multiple Users travelling on the same route, and all these Users are visible on the User's navigation map view simultaneously allowing them to travel in an organised manner. This is useful in long distance inter-city trips or intra-city ride-sharing use cases for coordinating across multiple pickup locations and multiple travelers, where a single multi-digit route identity can be shared with all travelers for them to stay and travel across multiple vehicles.

In one embodiment, the application supports scheduled tracking service where the application 110 can be programmed from the backend to wake up at predefined duration and intervals to log the precise User location and make it available for real time access or historical transportation analysis.

In another embodiment the application 110 supports tracking the user device and user delivery completion status by the remote centralized server at predefined durations and intervals to track the precise User locations and precise new pickup and delivery requests in real time and assign optimal mapping of pickup requests to the best suited drivers, such that they are able to meet the previously agreed upon pickup and delivery timelines, subject to availability of riders.

Written physical addresses meant for courier or parcel shipment often have mis-spelt addresses or inaccurate addresses that quite often do not have a matching entry in maps databases. In such cases, it involves human intelligence task to search for individual elements of the address separately hoping to find a match on the map. This task can be very time-taking and arduous and usually fruitless due to common names used in address elements such as Krishna Lane, Ganesh Road, MG Road etc. Further embodiments of multi-destination dynamic routing application system applies heuristics such as replacing abbreviations for (Apt) apartment, (CHS) cooperative housing society, (Flr) floor, (Bld) building, (Nr) Near, (P.O.) Post Office etc with full-forms which improves the map content matching. Other rules include removing the first address line in case of no match found. The matching algorithm then processes each address line one by one and parses the output for partially-matching list of locations every time. Among all the partially matching locations, the ones that are closest and most frequently appearing for each address line are chosen as best overall-matches. Results indicate matching up to 70-80% of all non-searchable addresses with some of these heuristic rules, which drastically improves the location accuracy and manual information entry time into any delivery compliance database or GPS navigation device, thereby further providing cost-reduction as well as time and fuel saving opportunities to enterprise Users.

Working Offline with Internet Connectivity and Advantages:

Application 110 caches and sequences destination data preventing data losses, and allows Users to modify the data before syncing it to the server (Eg. Confirming destination on second visit, before syncing the information to the server). This application 110 stores data and checks the quality of the connection from time to time and uploads when the data transmission speeds are good and other uploads are not hogging data bandwidth.

User 108 cannot switch off his application since it contains the drops and task details, hence will find it difficult to turn off the real time location tracking feature. User 108 can however work offline without any hindrances, if the User wants, and complete the tasks at his pace without continuous monitoring. Manager is free to use the real-time location retrieval functionality using SMS to retrieve the User's last known location, but he cannot access the User's entire location history for the route if the delivery person is using the application 110 offline. User 108 can then switch on the internet or data transmission once he has completed his tasks for the day. This gives the User 108 liberty to complete his tasks as per his pace, and the manager the power to monitor and analyze his movements and task completions over the course of the day.

### Exemplary System Architecture

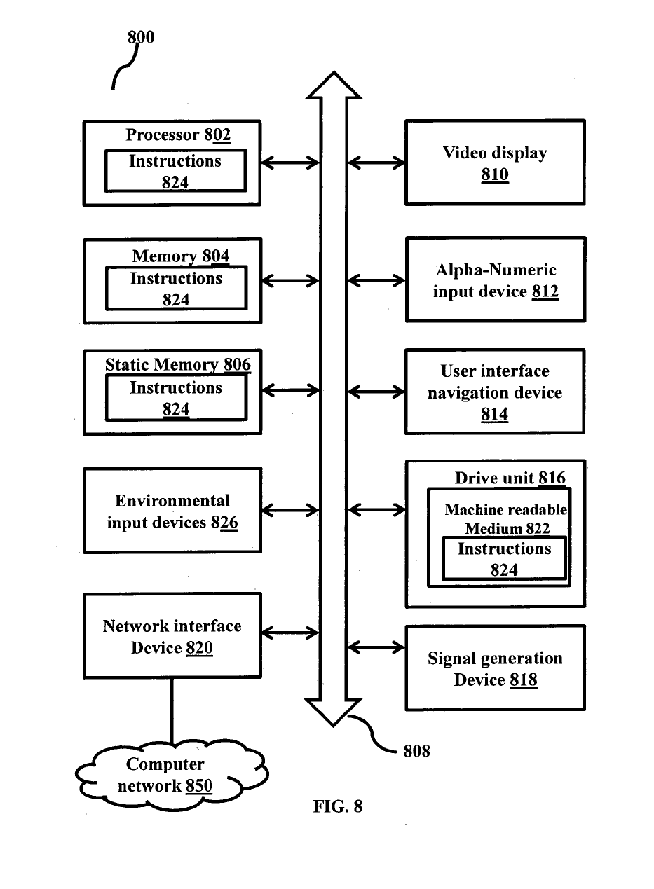

FIG. 8 is a block diagram of a machine in the example form of a computer system 800 within which instructions for causing the machine to perform any one or more of the methodologies discussed herein may be executed. In alternative embodiments, the machine operates as a standalone device or may be connected (e.g., networked) to other machines.

In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), cellular telephone, a web appliance, a network router, switch or bridge, or any machine capable of executing instructions (sequential or otherwise) that specify actions to be taken by that machine.

Further, while only a single machine is illustrated, the term “machine” shall also be taken to include any collection of machines that individually or jointly execute a set (or multiple sets) of instructions to perform any one or more of the methodologies discussed herein. The example machine 800 includes a processor 802 (e.g., a central processing unit (CPU), a graphics processing unit (GPU), or both), a main memory 804, and a static memory 806, which communicate with each other via a bus 808.

The computer system 800 may further include a video display unit 810 (e.g., a liquid crystal display (LCD) or a cathode ray tube (CRT)). The computer system 800 also includes an alphanumeric input device 812 (e.g., a keyboard), a User interface (UI) navigation device 814 (e.g., a mouse), a disk drive unit 816, a signal generation device 818 (e.g., speaker), and a network interface device 820.

The computer system 800 may also include a environmental input device 826 that may provide a number of inputs describing the environment in which the computer system 800 or another device exists, including, but not limited to, any of a Global Positioning Sensing (GPS) receiver, a temperature sensor, a light sensor, a still photo or video camera, an audio sensor (e.g., a microphone), a velocity sensor, a gyroscope, an accelerometer, and a compass. The disk drive unit 816 includes a machine-readable medium 822 on which is stored one or more sets of data structures and instructions 824 (e.g., software) embodying or utilized by any one or more of the methodologies or functions described herein.

The instructions 824 may also reside, completely or at least partially, within the main memory 804 and/or within the processor 802 during execution thereof by the computer system 800, the main memory 804 and the processor 802 also constituting machine-readable media. While the machine-readable medium 822 is shown in an example embodiment to be a single medium, the term “machine-readable medium” may include a single medium or multiple media (e.g., a centralized or distributed database, and/or associated caches and servers) that store the one or more instructions 824 or data structures.

The term “non-transitory machine-readable medium” shall also be taken to include any tangible medium that is capable of storing, encoding, or carrying instructions for execution by the machine and that cause the machine to perform any one or more of the methodologies of the present subject matter, or that is capable of storing, encoding, or carrying data structures utilized by or associated with such instructions. The term “non-transitory machine-readable medium” shall accordingly be taken to include, but not be limited to, solid-state memories, and optical and magnetic media.

Specific examples of non-transitory machine-readable media include, but are not limited to, non-volatile memory, including by way of example, semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

The instructions 824 may further be transmitted or received over a computer network 850 using a transmission medium. The instructions 824 may be transmitted using the network interface device 820 and any one of a number of well-known transfer protocols (e.g., HTTP). Examples of communication networks include a local area network (LAN), a wide area network (WAN), the Internet, mobile telephone networks, Plain Old Telephone Service (POTS) networks, and wireless data networks (e.g., WiFi and WiMAX networks).

The term “transmission medium” shall be taken to include any intangible medium that is capable of storing, encoding, or carrying instructions for execution by the machine, and includes digital or analog communications signals or other intangible media to facilitate communication of such software.

As described herein, computer software products can be written in any of various suitable programming languages, such as C, C++, C#, Pascal, Fortran, Perl, Matlab (from MathWorks), SAS, SPSS, JavaScript, AJAX, and Java. The computer software product can be an independent application with data input and data display modules. Alternatively, the computer software products can be classes that can be instantiated as distributed objects. The computer software products can also be component software, for example Java Beans (from Sun Microsystems) or Enterprise Java Beans (EJB from Sun Microsystems). Much functionality described herein can be implemented in computer software, computer hardware, or a combination.

Furthermore, a computer that is running the previously mentioned computer software can be connected to a network and can interface to other computers using the network. The network can be an intranet, internet, or the Internet, among others. The network can be a wired network (for example, using copper), telephone network, packet network, an optical network (for example, using optical fiber), or a wireless network, or a combination of such networks. For example, data and other information can be passed between the computer and components (or steps) of a system using a wireless network based on a protocol, for example Wi-Fi (IEEE standards 802.11, 802.11a, 802.11b, 802.11e, 802.11g, 802.11i, and 1802.11n). In one example, signals from the computer can be transferred, at least in part, wirelessly to components or other computers.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

We claim:

1. A method for multi-destination dynamic routing in logistics, the method comprising of:
synchronizing at least one user device with a remote centralized server by establishing communication between at least one user device and the remote centralized server;
providing the remote centralized server with at least one input corresponding to at least one user current location and destination location via user device;
downloading at least one route map associated with at least one route between the current location and the destination location from the remote centralized server to at least one user device;
providing access to at least one User for manipulating at least one downloaded route map; and
tracking and obtaining by the user device from the remote centralized server at least one user location on at least one route between the current location and the destination location at plurality of time instances.

2. The method of claim 1 wherein synchronizing at least one user device with a remote centralized server by establishing communication includes receiving by the remote centralized server information inputs from a user device including emergency alerts, recent road constructions, traffic diversions and store associated data, process route information, generate a route map, manage other users, change user settings, downloading user tasks and priorities, adding the days custom drops by the User via the user device and downloading by the user device all the associated route map, directions, user tasks and priorities for the day from the remote centralized server based on custom drop addition: wherein, adding the days customs drops includes adding destinations for out of turn deliveries for the day and downloading route map for out of turn delivery and resuming the original route with completed stops and remaining stops, once the out of turn delivery is completed.

3. (canceled)

4. (canceled)

5. (canceled)

6. The method of claim 1 wherein, downloading includes downloading the route map in the navigation view of the user device wherein the navigation view provides a view of the remaining driving directions in a visual manner with three-dimensional projection along with neighboring destinations, point of interests (POIs and accessing three-dimensional map view of the route map in the user device which provides for toggling and scrolling among all the tracked users one after the other.

7. (canceled)

8. The method of claim 1 wherein, establishing communication between at least one user device and the remote centralized server includes communicating at least one identified route map information comprising route irregularity data detecting road bumps and potholes corresponding to at least one route between the current location and the destination location and wherein, establishing communication with at least one user device by the remote centralized server includes establishing communication by email, chat based applications or short messaging service (SMS) protocol which communicates user requests and directions between at least one user device and the remote centralised server.

9. The method of claim 8 wherein, route irregularity data is processed by a bump detection algorithm which separates out the continuous vehicle movements from the user device movements detecting the measure of bumps during transportation of the package contents which are subjected to when the user device is firmly attached to the package thus alerting the User including the driver by visual or audible means of the route irregularity ahead on the way, by the user device and indicating the final measure of physical damage to the package contents by visual or audible means to at least one User including the driver.

10. (canceled)

11. The method of claim 9 wherein route irregularity data processed by a bump detection algorithm further includes detecting the measure of bumps during transportation when the user device is not attached to the vehicle but in constant motion along with the vehicle and indicating the measure of bumps to at least one User including the driver.

12. The method of claim 1 wherein, downloading includes providing access to at least one downloaded route map with one of hands-off and eyes-off touch less hand gesture recognition comprising of capturing the palm of the User when placed in front of the user device camera thus enabling calibrating the current map view to the palm and tracing the palm movements and gestures to the camera perspective of the map view.

13. The method of claim 1 wherein, establishing communication includes communicating with the remote centralized server and the plurality of user devices in continuous or discontinuous motion and wherein the user location is seen in real time on a map with appropriate track points.

14. The method of claim 1 wherein, establishing communication includes providing information by the remote centralized server of freed up parking spots in real time to the User happening to be in the neighborhood through the user device.

15. The method of claim 1 wherein, establishing communication between at least one user device and the remote centralized server, includes tracking a route compliance of the User in real time and bringing up a reason code screen in the user device which requires a single touch by the User to record the reason behind deviating from an original route and wherein communication further includes analyzing and modifying the source and destinations by the remote centralized server based on reason code screen input by the User.

16. The method of claim 1 wherein establishing communication between at least one user device and the remote centralized server further includes querying for all Point of Interests (POIs) tagged as fuel or fueling points in a given radius of vehicle stoppage point and feeding inputs to the remote centralized server the fuel logs of the Users vehicle.

17. The method of claim 1 wherein communication between at least one user device and the remote centralized server further includes translating the voice mode user inputs made over the user device into phonetic translation into English language for feeding inputs to the remote centralized server and receiving back the voice mode response in the user device from the remote centralized server in the voice mode of the user input.

18. The method of claim 1 wherein establishing communication between at least one user device and the remote centralized server further includes tracking the user device by the remote centralised server at predefined durations and intervals to log the precise user locations for real time access and providing user device with tracking past location history.

19. The method of claim 1 wherein establishing communication between at least one user device and the remote centralized server includes tracking by the User the specific package carried on by a vehicle and establishing communication with the user device associated with that vehicle by the User.

20. The method of claim 1 wherein establishing communication between the user device and the remote centralized server further includes replacing abbreviations, by the remote centralized server in the delivery address input of the User, with full-forms for address content matching and removing the first address line in case of no match found and wherein the matching algorithm processes each address line and parses the output for the user device for partially-matching list of locations.

21. The method of claim 1 wherein establishing communication between the user device and the remote centralized server further includes communicating by the remote centralized server to the user device, in its navigation map view, at least one other user travelling on the same route such that similar such travelers are coordinated to stay and travel in multiple vehicles by providing a multi-digit route identity.

22. (canceled)

23. The method of claim 1 wherein establishing communication between the user device and the remote centralized server includes tracking the user device and user delivery completion status by the remote centralized server at predefined durations and intervals to track the precise user locations and precise new pickup and delivery requests in real time and assign optimal mapping of pickup requests to suitable drivers, such that the drivers are able to meet the previously agreed upon pickup and delivery timelines.

24. (canceled)

25. (canceled)

26. The Multi-destination dynamic routing application system comprising of;
At least a remote centralized server configured to remotely manage at least one User with the user device comprising of a co-ordination database, an authentication module, a route generation module, an application program interface (API) module and a communication module all integrated to function as a multi-destination dynamic routing application;
At least a network configured to establish communication pathways between the remote centralized server and the user device; and
At least one user device configured to comprise of a User interface module, a tracking module, an application program interface (API) module, a touch less gesture recognition and navigation module, at least a camera and a communication module all integrated to function as a multi-destination dynamic routing application.

27. The method of claim 1 wherein synchronizing at least one user device with a remote centralized server by establishing communication between at least one user device and the remote centralized server includes combining closely located destinations for same deliveries using same vehicle by a metric called clustering, only if the located destinations are both large such that they attract each other towards a central point.

29. The method of claim 18 wherein clustering includes combining similar clusters based on the similarity in the type of deliveries and wherein clustering is prioritized by the distance priority mix governed by the formula: Balanced: distance*priority, Priority oriented: (d*pd′) (1+0.1*(Pd′−Ps′)), where, d=rectilinear distance between the source and destination Pd=destination, Pd′=Priority of destination/μ, Ps=Priority of source, Ps′=Priority of source/μ, μ=priority number of most important point among all the drops and wherein priority may be chosen to be rank ordered or value based.
